(19) United States
(12) Patent Application Publication
(10) Pub. No.: US 2024/0271599 A1
(43) Pub. Date: Aug. 15, 2024

(54) METHOD FOR AVOIDING MECHANICAL VIBRATIONS OF A WIND POWER INSTALLATION

(71) Applicant: Wobben Properties GmbH, Aurich (DE)

(72) Inventors: Martin Flögel, Mölln (DE); Enno von Aswege, Großefehn (DE)

(21) Appl. No.: 18/436,960

(22) Filed: Feb. 8, 2024

(30) Foreign Application Priority Data
Feb. 9, 2023 (EP) 23155804.0

(51) Int. Cl. F03D 7/02; F03D 17/00

(52) U.S. Cl. CPC F03D 7/0298; F03D 17/015; F05B 2260/964; F05B 2270/328; F05B 2270/334

(57) ABSTRACT

The invention relates to a method for controlling a wind power installation, wherein the wind power installation has a tower, a generator and a rotor with rotor blades whose blade angle can be adjusted, an operating point is characterized by an installation power and a rotor speed, to change or maintain the operating point, at least one actuator is controlled in each case via a control variable, and controlling the actuator affects a vibration excitation of at least one component vibration of a vibratory component of the wind power installation, comprising the steps of: determining a preliminary control signal for the control variable, changing the preliminary control signal into a modified control signal in order to reduce the vibration excitation, wherein the preliminary control signal is changed into the modified control signal in such a way that at least one frequency component from the preliminary control signal with a frequency range around a natural frequency of the vibratory component is reduced, and/or at least one frequency component from a resulting excitation signal, which is expected from the preliminary control signal and excites the component vibration, with a frequency range around the natural frequency of the vibratory component is reduced, and controlling the actuator on the basis of the modified control signal.

### BACKGROUND

### Technical Field

Embodiments of the present invention relate to a method for controlling a wind power installation. In addition, embodiments of the invention relate to a corresponding wind power installation.

### Description of the Related Art

Wind power installations are known; they generate electrical current from wind. A wind power installation is also exposed to the wind which can cause a load.

A possible load is that the wind power installation can vibrate mechanically. In the steady state, such vibrations can be reduced in particular by selecting a suitable rotor speed.

It also comes into consideration that manipulated variables, especially changes in manipulated variables, can excite a vibration of the wind power installation.

Such manipulated variables can be in particular the adjustment of blade angles of the wind power installation and a change of a generator torque of the generator of the wind power installation. A manipulated variable for adjusting the azimuth orientation of the nacelle of the wind power installation also comes into consideration.

The rotor blades and the tower of the wind power installation in particular can be prone to vibrations and can be considered to be vibratory components. Both the rotor blades and the tower can perform bending vibrations and torsional vibrations, which may depend in particular on the respective excitation.

If such manipulated variables are specified in steps, this can excite a vibration. A recurring, in particular oscillating, specification of a manipulated variable can also excite a vibration, depending on the frequency.

Excitation of vibrations by manipulated variables can be avoided in particular by not specifying these manipulated variables in steps or in an oscillating manner. In particular, control with a step-like manipulated variable can result, however, from a need to quickly change the operating point. A quick reduction in the speed that is required for safety reasons in particular can lead to a step-like manipulated variable. However, even strong changes, especially in the wind speed or wind direction, can lead to large, especially step-like manipulated variables, or the like.

It is therefore often hardly possible to specify only a gentle, in particular ramp-like, manipulated variable.

### BRIEF SUMMARY

Some embodiments address at least one of the mentioned problems. In particular, the intention is to propose a solution in which large manipulated variable changes are possible without excessively exciting a vibration of the wind power installation. The intention is at least to propose an alternative to previously known methods.

In some embodiments, a method relates to the control of a wind power installation, which may also include the regulation of a wind power installation. The wind power installation has a tower, a generator and a rotor with rotor blades whose blade angle can be adjusted. The wind power installation may have an operating point characterized by an installation power and a rotor speed. The installation power can denote the power that the wind power installation generates and feeds into an electrical supply grid, i.e. the electrical power that is delivered by the wind power installation. It can also, in a simplified way, correspond to or be equated with the generator power generated by the generator. Both powers are not identical, because losses can still be incurred, especially from the generator power to the delivered power, and power components for controlling or operating the wind power installation may be lost, but these differences can be disregarded for explaining the present embodiments.

To change or maintain the operating point, at least one actuator is controlled in each case via a control variable. Such an actuator can be a blade adjustment device for changing the angle of attack of a rotor blade. A plurality of rotor blades are usually provided, but at the same time can be adjusted independently of each other in terms of their blade angle, for which a blade adjustment device is respectively used. In a simplified way, however, all blade adjustment devices can be considered together, especially if they each receive the same control signal. An adjustment device for adjusting the azimuth orientation of the wind power installation, i.e. an adjustment device for adjusting the orientation of the nacelle of the wind power installation, can also be such an actuator. The signal that specifies the adjustment of the blade adjustment device or the azimuth adjustment device is understood as a control signal. A value of such a control signal can be referred to as a control variable.

A further control variable can be a variable as a specification for a generator torque. A generator-side inverter that controls in particular appropriate stator currents of the generator can be the corresponding actuator.

The control variable or a control signal for a blade adjustment device can be a blade angle, a differential blade angle or an adjustment rate for the blade adjustment device. Such a blade angle, blade angle difference or blade angle adjustment rate can be directly specified as a target variable, for example by a corresponding controller, or can be the result of a regulating process. The same applies to the azimuth adjustment device in which an azimuth angle, an azimuth differential angle or an azimuth adjustment rate can be the control variable. Here, too, this control variable or the control signal can be specified directly or can be the result of a regulating process. For both cases, it also comes into consideration to calculate the control variable or the control signal from a different specification.

For the generator torque, its magnitude or change can be the control variable or the control signal. Here, too, this control variable can be specified directly or can be the result of a regulating process. In the case of the generator torque as a control signal, it also comes into consideration, in particular, that this is calculated from a specified generator power. The specified generator power can in turn be specified directly or be the result of a regulating process. The result of a regulating process can be understood as meaning that this result results from a target/actual value comparison, directly or indirectly, in particular after the target/actual value comparison results in a control deviation which was given via a regulator.

Controlling the actuator affects a vibration excitation of a component vibration of a vibratory component of the wind power installation. Based on this, it is further proposed to determine a preliminary control signal for the control variable and to change the preliminary control signal into a modified control signal in order to reduce the vibration excitation. Changing the preliminary control signal into the modified control signal can also be referred to as modifying. The vibration excitation should therefore be reduced when using the modified control signal in comparison with control with the preliminary control signal, i.e. without modification.

For this purpose, it is proposed that the preliminary control signal is changed into the modified control signal in such a way that the amplitude of at least one frequency component from the preliminary control signal with a frequency range around a resonant frequency of the vibratory component is reduced, that is to say a frequency component corresponding to the natural frequency of the vibratory component is intended to be removed. However, no frequency component that corresponds exactly to the natural frequency can be removed. Therefore, a frequency component in the region of the natural frequency is removed. In particular, the frequency range around the natural frequency can be described as a range of 10% above and below the natural frequency. At least in such a frequency range, a frequency component is intended to be removed from the preliminary control signal.

The explanation of the removal should also be understood clearly and instead the frequency component of the frequency range mentioned is reduced. The preliminary control signal is reduced by at least 50%, in particular in the frequency range around the natural frequency, i.e. in particular in this range of +/−10% around the natural frequency.

Finally, the actuator is controlled on the basis of the modified control signal. This means in particular that the modified control signal is passed to the respective actuator for implementation. However, the control signal can, of course, be subjected to further changes which are required for data transmission, for example, or it can be transferred from a digital signal to an analog signal, to name just two illustrative examples. In principle, however, the actuator is controlled in the way specified by the modified control signal.

It was recognized, in particular, that strong control of an actuator can occur in particular as a step-like signal. Especially when an operating point is changed, a target value is changed in a step-like manner and this target value changed in a step-like manner can form the preliminary control signal and this step-like target value is thus changed into a modified target variable that forms the modified control signal. Such a modification can be provided directly for the step-like target variable. However, it also comes into consideration that the modification only takes place in the control loop, i.e. after a target/actual value comparison or even downstream of a regulator after a target/actual value comparison. If the wind power installation is in a steady operating state and a step-like target variable is then specified, the step-like target variable can also still be step-like after the target/actual value comparison, especially in the case of a P regulator. The target variable, whether now in a step-like or other form, can also be used directly as a control variable and thus as a control signal for the actuator.

Here it was recognized, in particular, that a step-like signal, or other signal forms, can contain various frequency components, including frequency components or frequency ranges that are within the range of the natural frequency of the vibratory component. Such components can be reduced in order to thereby reduce vibration excitation and/or vibration of the vibratory component, since vibratory components react most sensitively here.

In particular, a sudden torque change can excite a tower vibration. In this case, it is proposed that the natural frequency of the tower is taken into account in order to change the preliminary control signal into the modified control signal.

In the case of a sudden change in the blade angle, it comes into consideration, in particular, that a torsional vibration and/or bending vibration of the respective rotor blades is excited thereby and therefore a corresponding natural frequency of the respective rotor blade is taken into account, that is to say a frequency component in the range of the natural frequency of the rotor blade is reduced, to name another example. However, it also comes into consideration that not only one natural frequency, but a plurality of natural frequencies are taken into account. For example, a higher natural frequency of the tower vibration can be taken into account for a first natural frequency of a tower vibration. For example, a first and a third vibration mode of the tower can therefore be taken into account. In this case, two frequency components from the preliminary control signal can be reduced accordingly, namely one with a frequency range around the first natural frequency and another with a frequency range around the third natural frequency.

Additionally or alternatively, it is proposed that the preliminary control signal is changed into the modified control signal in such a way that at least one frequency component from a resulting excitation signal, which is expected from the preliminary control signal and excites the component vibration, with a frequency range around the natural frequency of the vibratory component is reduced. It is therefore proposed to consider the resulting excitation signal rather than the control signal. Accordingly, the preliminary control signal is changed into the modified control signal in such a way that at least one frequency component in the expected excitation signal is changed. This change is in turn a reduction in the frequency range around the natural frequency.

For further explanation, the control signal will lead to the excitation signal. If, for example, the control signal is a target value for a generator torque, the generator torque, or a force acting on the tower from the generator torque, can be the resulting excitation signal which is therefore expected. If there is a linear and time-invariant relationship between the control signal and the resulting excitation signal, or if this can be assumed at least simplistically, a change in a frequency component in the control signal leads to a corresponding change in the excitation signal. The change therefore has the same frequency range and the same relative amplitude in both signals.

The modification can then be carried out directly in the control signal and can be oriented to the natural frequency of the vibratory component, that is to say can in particular filter out a frequency component there.

However, if the relationship between the control signal and the resulting excitation signal is non-linear, such a procedure can be too inaccurate or even incorrect. Particularly then, it is proposed to make a modification using the expected resulting excitation signal. For this purpose, the expected resulting excitation signal can be determined from the preliminary control signal, e.g. from preliminary investigations and/or simulations, or suitable installation models can be used. The expected resulting excitation signal is then reduced by the frequency component with the frequency range around the natural frequency of the vibratory component, namely into a modified excitation signal. The modified control signal is then calculated back from the modified excitation signal.

If the relationship is linear and time-invariant, both ways of modifying the control signal should lead to the same result, namely to an excitation signal in which a frequency component with the frequency range around the natural frequency of the vibratory component is reduced.

According to one aspect, it is proposed that a damping signal is applied to the modified control signal in order to attenuate the at least one component vibration. This is done in particular in such a way that the damping signal is determined on the basis of at least one detected component vibration.

Thus, in a first step, the preliminary control signal is changed into the modified control signal. This can be done in particular independently of detected signals. The preliminary control signal can be in particular a specified target value, i.e. a specified target signal, in particular a step-like target signal. Its change into the modified control signal only requires the at least one natural frequency of the at least one vibratory component. Such a natural frequency is often well known, as it forms a fixed system property. If necessary, it may be reviewed after a relatively long period of time and adjusted, if necessary.

The damping signal is applied to this modified control signal. The damping signal can depend, in particular, on the detected component vibration and can be based, in particular, on feedback of the detected component vibration. Such feedback can be temporally derived, integrated and/or phase-shifted for this purpose.

Here it was recognized in particular that the preliminary control signal is changed into the modified control signal independently of a detected component vibration and thus fundamentally always with the same amplitude, at least for the same preliminary control signals, as long as the damping signal is not applied.

However, the amplitude of the damping signal depends on the amplitude of the detected component vibration. If a very low component vibration is thus achieved by the modified control signal, only a damping signal of low amplitude is also produced. Changing the preliminary control signal into the modified control signal therefore follows a different strategy than applying the damping signal. However, both approaches are intended to reduce component vibrations.

In addition, the application of the damping signal to the modified control signal is proposed, with the result that the modification does not affect the applied damping signal. Here it was recognized, in particular, that otherwise the modification could reduce the effect of the damping signal again, and possibly even extinguish it, because the frequency of the damping signal will often also be close to the natural frequency of the vibratory component. Precisely such a frequency component would therefore be removed during the modification.

The two measures therefore have a synergistic effect. Apart from that, the damping signal can also damp component vibrations caused in a manner other than by the control signal.

According to one aspect, it is proposed that, in order to change the preliminary control signal into the modified control signal, use is made of a band-stop filter, in particular a notch filter, which reduces the at least one frequency component from the preliminary control signal. Thus, the preliminary control signal can be filtered via this notch filter, and the notch filter can be set to the respective natural frequency. It also comes into consideration that a further notch filter is used if more than one natural frequency is to be taken into account.

The notch filter can also be applied to a resulting excitation signal expected for a preliminary control signal in order to obtain a modified excitation signal which is transformed back into the modified control signal. This would also apply the notch filter to the preliminary control signal.

The method can thus be implemented in a simple way, and the notch filter can also be used to set the extent to which the respective frequency component is intended to be reduced and to also set how narrow the frequency range around the respective natural frequency should be selected to be.

According to one aspect, it is proposed that the preliminary control signal is step-like, is a specified target value and/or is specified for changing the operating point. Here it was recognized, in particular, that a step-like control signal can have frequency components close to at least one natural frequency and these can be reduced by the proposed change into the modified control signal in order to avoid a vibration excitation.

It has also been recognized that even changing a specified target value, especially if it is step-like, into a modified signal can avoid vibration excitations.

It has also been recognized that a control signal can occur especially when changing the operating point, namely can be generated in particular by corresponding control rules which can excite vibrations. In particular, it was recognized that changing the operating point can be a significant change. In particular, possible changes in the operating point, which can be critical, are strong reductions in the rotor speed or strong reductions in the installation power. Such operating points in particular can lead to very significant changes and thus very large control signals, in particular step-like control signals, which occur less frequently and/or to a lesser extent simply due to changes in the wind speed.

According to one aspect, it is proposed that the control variable is a target torque value of the generator of the wind power installation, and in particular the target torque value is determined from a received target power value. This aspect therefore involves controlling the generator via the generator torque, which can be considered a synonym for the torque of the generator.

The resulting vibration excitation is here an excitation of a tower vibration, in particular a bending vibration of the tower. It was recognized here that controlling the generator torque, especially if this is changed in an approximately abrupt manner thereby, can lead to a kind of torque jerk which in turn can lead to a movement of the generator transversely with respect to the generator axis. This allows the tower to vibrate transversely with respect to the generator axis and thus transversely with respect to the wind, especially in the head area, when the wind power installation is oriented into the wind.

For this purpose, it is proposed that the modified control signal is determined in such a way that a frequency component around the natural frequency of the tower is reduced, in particular with reference to a bending vibration of the tower.

Here it was recognized, in particular, that such a jump in torque can lead to such a bending vibration of the tower and that this can be avoided or at least reduced by reducing the target torque value by the frequency component which lies around the natural frequency of the tower. However, it also comes into consideration here that a further natural frequency of the tower can be additionally considered by removing or reducing a further frequency component from the target torque value around such a second natural frequency. As a result, the service life of the tower can be extended or a shortening of the service life of the tower can be avoided, but without significantly delaying or weakening the implementation of the original target torque value.

According to one aspect, it is proposed that the control variable is a blade angle or a pitch rate for adjusting a blade angle in each case, and in particular the blade angle or the pitch rate is determined from a request for adjustment and/or a change in the rotor speed, the resulting vibration excitation is an excitation of at least one blade vibration, in particular a torsional vibration of the blade, and/or a collective vibration mode of the blades together with a spinner or a hub, and the modified control signal is determined in such a way that a frequency component around the natural frequency of the blade is reduced, in particular with reference to the torsional vibration of the blade, or the modified control signal is determined in such a way that a frequency component around the natural frequency of the collective vibration mode of the blades and the spinner or the hub is reduced.

Here it was recognized, in particular, that the adjustment of the blade angle, whether directly or via the specification of a pitch rate, can lead to a torsional vibration of the rotor blade, which can be specifically excited by the adjustment. In order to reduce this, it is proposed to change the corresponding control variable, i.e. a specification of the blade angle or a specification of a pitch rate, in such a way that a corresponding vibration-exciting frequency component is reduced.

Such a control signal can be used in particular to regulate or change the rotor speed. The proposed solution also makes it possible to quickly adjust the blade angle of the rotor blades while simultaneously reducing a vibration excitation.

According to one aspect, it is proposed that the at least one actuator is controlled via the at least one control variable in order to change the current operating point to a new operating point, and that the wind power installation at the new operating point relative to the old operating point has a reduced installation power and/or a reduced speed. Additionally or alternatively, it is proposed that the new operating point is an installation stop. Additionally or alternatively, it is proposed that the preliminary control signal is intended for the fastest possible change to the new operating point. In particular, it is intended for an emergency shutdown of the wind power installation and/or emergency braking of the rotor.

A change in the operating point is therefore proposed and this is effected by means of the control variable and thus the preliminary and then modified control signal. The new operating point can be a reduced installation power, namely in comparison with the current operating point, i.e. the operating point from which the change starts, to which the control signal is thus applied. In particular, a reduction in the installation power by at least 50% in comparison with the installation power at the current operating point is planned, up to a reduction in the installation power to zero. Here it was recognized in particular that such strong reductions in the installation power cause correspondingly strong control signals that can trigger vibrations.

Another variant is that the new operating point has a reduced speed, i.e. a reduced speed in comparison with the current operating point. In particular, the speed is reduced by at least 50% in comparison with its previous value at the current operating point. It also comes into consideration that the speed is reduced to zero. Here too, a significant change in the operating point, namely strong deceleration of the rotor, i.e. a strong reduction in the rotor speed, which is synonymous with speed, is assumed. Here too, a vibration excitation can be expected, and so the proposed measure for avoiding such a vibration excitation is proposed.

Accordingly, the new operating point can be an installation stop where the installation power is reduced to zero and/or the speed is reduced to zero. Thus, an installation can be stopped quickly, while at the same time avoiding an excessively strong vibration excitation of the at least one vibratory component. In particular, a vibration excitation of the tower is avoided or kept to a minimum here.

In particular, an emergency shutdown or emergency braking can be carried out hereby. Changing the control signal avoids the excitation of a vibration, in particular a tower vibration, but at the same time does not significantly delay the emergency shutdown or emergency braking.

According to one aspect, it is proposed that the preliminary control signal is specified as a time course, with values that vary several times and/or continuously, in particular with a plurality of temporally distributed supporting points, wherein the course has a linear section between two adjacent supporting points in each case. The course of a supporting control signal is thus specified. Such a specification or such a time course goes beyond a step-like course which, although also having a change in its value at its saltus, does not have values that vary several times or continuously. However, it is not excluded that a step-like course can be part of the time course, in which, for example, the time course begins with a step-like course.

Such a time course may be provided for a specific control objective, for which it is possible to predetermine which course of a control variable is needed to achieve this objective.

In particular, the time course may have a plurality of temporally distributed supporting points, wherein the course has a linear section between two adjacent supporting points in each case. The time course can thus be specified by these supporting points and thus a simple specification is possible, which requires hardly any storage space during digital conversion.

A time course of the control signal, whether it is now by specification of supporting points or otherwise, can, for example, first of all jump to a first value in order to control a blade adjustment device, can then increase linearly over time in order to adjust the rotor blade as quickly as possible, and can then decrease linearly again in order to continue the adjustment of the rotor blade at a high, but nevertheless decreasing, adjustment speed. The adjustment speed which decreases slightly again makes it possible for the end position of the rotor blade to be reached more smoothly, to name just one example.

Also for such a control signal which is specified over a time course, it is advantageous to reduce this signal by a frequency component with a frequency range around at least one natural frequency of a vibratory component. The intended course of the blade adjustment is hardly affected by this, but the excitation of a vibration, which in the present example can be in particular a torsional vibration of the rotor blade, is avoidable thereby, and at least a corresponding excitation can be reduced.

The use of distributed supporting points can be realized in particular by virtue of the fact that these supporting points are stored in a table. If required, these stored values can be accessed and the control signal can also be well defined via supporting points with a connecting linear section and then changed into the modified control signal.

According to one aspect, it is proposed that, depending on a target working point to be headed for, in particular for carrying out an emergency stop, and optionally depending on a current working point, a time course of the preliminary control signal is selected, in particular from a table. This is based in particular on the idea that a new target working point should be approached as quickly as possible. An emergency stop is one such possible target working point. In order to approach this emergency stop, or another working point, the rotor blades must be adjusted as quickly as possible. A generator torque for braking is possibly also additionally set.

The manner in which rotor blades can be adjusted for such an emergency stop or other target working point can be known or predeterminable. It comes into consideration, in particular, that corresponding blade adjustment drives are accelerated as quickly as possible to a maximum adjustment speed and are reduced to an adjustment speed of zero as late as possible at the end of the adjustment of the rotor blades. Such an intended and/or ideal course can be stored in a table and form the preliminary control signal. Such a course may also have a frequency component with a frequency range around a natural frequency. Therefore, it is proposed to also change such a preliminary control signal into a modified control signal in order to reduce this frequency component in order to thereby reduce the excitation of the at least one natural frequency.

What exactly this control signal looks like, in particular what exactly a blade adjustment or blade adjustment rate looks likes, also depends on the current operating point. If the wind power installation is operating at rated speed, it may take longer to decelerate the rotor. During such rated operation in particular, the speed is high and it may take longer to reduce it. Accordingly, a different time course of the preliminary control signal can result than if the speed to be reduced is already lower than the rated speed.

Therefore, it may be advantageous to also determine the time course of the preliminary control signal on the basis of a current working point.

As a result, even for this one target working point of the emergency stop, various preliminary control signals can result, namely depending on the current working point. In addition, other working points can also come into consideration as target working points, and so many possibilities can arise for the time course of the preliminary control signal.

Such many possibilities can be stored in a table and, in order to determine the preliminary control signal, only the time course of the preliminary control signal needs to be selected from the table, namely in particular depending on the current working point and the target working point. It is particularly advantageous if the preliminary control signals, which are stored as time courses in the table, are stored by the use of supporting points, in particular a few supporting points. A large number of possible preliminary control signals can then be stored with little memory expenditure.

Interpolating between two or more stored preliminary control signals comes into consideration. If, for example, the current speed is 11.5 revolutions per minute, but only preliminary control signals for a speed of 11 revolutions per minute and 12 revolutions per minute are stored in the table, it is possible to interpolate between these two stored preliminary control signals. For this purpose, it is possible, for example for the supporting points, i.e. at the respective associated points in time, to interpolate between the two values for the relevant point in time.

According to one aspect, it is proposed that the control variable is a blade angle or a pitch rate for adjusting the blade angle of one of the rotor blades in each case, and in particular the blade angle or the pitch rate is determined from a request for adjustment and/or a change in the rotor speed, and that the modified control signal is determined in such a way that at least one frequency component with a frequency range around at least one natural frequency of the tower, in particular around a natural frequency of bending of the tower in the pitch direction, is reduced.

It is therefore proposed in particular to take into account a control signal for changing the blade angle of the rotor blades. It was recognized here, in particular, that adjusting the blade angles of the rotor blades, especially if this is done quickly, can reduce a wind load on the rotor, depending on the adjustment direction, which reduces a force in the pitch direction on the wind power installation, with the result that a vibration of the tower in the pitch direction can result. Therefore, it is proposed to change the preliminary control signal into the modified control signal in such a way that a corresponding frequency component is reduced, with the result that such a vibration excitation of the tower in the pitch direction is reduced.

It was also recognized that the relationship between the blade adjustment and a resulting excitation signal that excites the tower vibration must not be linear and time-invariant, and thus it comes into consideration that a frequency spectrum of the control signal changes toward the resulting excitation signal. In that case, a frequency component in the excitation signal with a frequency range around a natural frequency of the tower does not have to correspond exactly to a frequency component with a frequency range around the natural frequency of the tower in the control signal. In the case of non-linear relationships, it even comes into consideration that an amplitude distribution will also change.

For this case, it is additionally or alternatively proposed to determine the modified control signal in such a way that at least one frequency component from a resulting excitation signal, which is expected from the preliminary control signal and excites the tower vibration, with a frequency range around a natural frequency of the tower is reduced. Here too, a natural frequency of bending of the tower in the pitch direction can be taken as a basis, in particular. Such a relationship between the frequency component in the excitation signal and a corresponding frequency component in the preliminary control signal can be determined by preliminary investigations or by simulations. Such a relationship can also be amplitude-dependent, i.e. dependent on the amplitude of the control signal. The relationship may also depend on the magnitude of the prevailing wind. These relationships can also be determined by preliminary investigations and/or simulations and stored. They can then be retrieved in the use case.

According to one aspect, it is proposed that the at least one natural frequency of the at least one vibratory component is determined during operation from recorded measurement variables, in particular by using parameter identification, and the preliminary control signal is changed into the modified control signal using this at least one determined natural frequency, and/or the preliminary control signal is changed into the modified control signal adaptively by adapting at least one natural frequency used to the at least one detected natural frequency.

A natural frequency of a system or here of a vibratory component is a system property and in this respect is invariable as long as the system does not change. However, it was recognized that a change in the system comes into consideration. Rotor blades in particular can change their stiffness over time and/or a degree of contamination can cause a change. Special operating situations in which a natural frequency can change also come into consideration; namely in particular icing of a rotor blade can be such a special operating situation.

It was also recognized that the detection of a natural frequency can also be advantageous in a new installation, i.e. when setting up a wind power installation or changing a wind power installation, because the correct natural frequency is detected thereby.

In particular, the natural frequency of the tower of a wind power installation can be known from the tower design, but it can be influenced by the foundations. The extent to which the foundations allow a movement and can therefore change the natural frequency of the tower can depend, in particular, on the ground. However, it was also recognized that the natural frequency of the tower can be different in the pitch and yaw directions. A change in devices in the nacelle, which loads the tower, can also lead to a change in weight there and thus to a change in the natural frequency.

In addition, it was recognized that the more accurately the natural frequency is known in each case, the more precise the modification of the control signal by the frequency component can be. If the natural frequency is well known, the frequency range of the frequency component around the natural frequency can be selected to be smaller, as a result of which a smaller component from the control signal must be reduced, as a result of which the control signal is changed all the less. This in turn leads to the fact that the preliminary control signal, i.e. the signal that should ideally be used, is changed as little as possible.

The natural frequency can be determined by detecting, for example, a free vibration of the respective component, i.e. a free vibration of the tower, for example. In this case, the detected vibration can correspond approximately to the natural frequency and can be used as the identified natural frequency.

Another possibility is to excite a vibration specifically, which can be done with a small amplitude, and then to detect the settling of the vibratory component, i.e. of the tower again, for example, or also of the rotor blade. This allows the natural frequency to be precisely determined, because such a decaying vibration is the definition of a natural frequency.

However, it also comes into consideration to record the natural frequency by means of parameter identification, in particular to also record it constantly during the running process, i.e. to also track it continuously if necessary. Such parameter identification can be carried out in particular in such a way that a model is operated parallel to the system, from which the natural frequency is intended to be identified. The at least one natural frequency then forms in the model a changeable variable which can be changed, e.g. by changing a parameter of the model, until the model and the system running in parallel behave in the same way, in particular have the same input/output behavior.

The natural frequency thus determined can then be used to change the preliminary control signal into the modified control signal. This modification therefore uses the determined, in particular identified, natural frequency, or a plurality of determined natural frequencies, if a plurality of natural frequencies are considered.

However, it also comes into consideration that a natural frequency is stored and is taken as a basis for changing the preliminary control signal into the modified control signal. If the at least one natural frequency is then determined, this stored natural frequency can be adjusted accordingly. In this respect, there is then an adaptive method for changing the preliminary control signal into the modified control signal.

According to one aspect, it is proposed that a speed reduction is specified depending on an endangered flying animal, in particular a bird or bat, approaching the wind power installation, depending on the specified speed reduction, a blade adjustment or pitch rate for adjusting the blade angle is determined as a preliminary control signal, and the preliminary control signal determined in this manner is changed into the modified control signal.

It was recognized here, in particular, that for species protection a rapid reduction in the speed of the rotor comes into consideration if an endangered animal flies toward the wind power installation, namely a bird or a bat of an endangered species in each case. In this case, the speed should be reduced as quickly as possible, which opens up the possibility of these animals being able to come as close as possible to the wind power installation before the speed reduction has to be carried out. The slower the speed reduction, the earlier, i.e. at the greater distance, and thus the more often, it must be initiated.

However, a rapid speed reduction can result in excessive mechanical loads by virtue of the excitation of a vibration of a vibratory component of the wind power installation, namely by an appropriate control signal. Therefore, it is proposed, especially in the case of such an approaching animal, to carry out a rapid speed reduction, which can be achieved by adjusting the blade angle of the rotor blades accordingly quickly. This control signal for adjusting the rotor blades is changed by a frequency component in the range of the natural frequency, namely into the modified control signal, in order to thereby nevertheless rapidly adjust the rotor blades. However, it takes place without excessive excitation of vibration, especially without excessive excitation of a torsional vibration of the rotor blades, but preferably also without excessive excitation of a pitching vibration of the tower by the likewise changing wind load on the rotor.

In some embodiments, a wind power installation is also proposed, wherein
the wind power installation has a tower, a generator and a rotor with rotor blades whose blade angle can be adjusted, and
an operating point is characterized by an installation power and a rotor speed, wherein
the wind power installation is prepared to be operated in such a way that
to change or maintain the operating point, at least one actuator is controlled in each case via a control variable, and
controlling the actuator affects a vibration excitation of at least one component vibration of a vibratory component of the wind power installation, and wherein
the wind power installation is prepared, in particular has an installation controller which is prepared, to carry out a method comprising the following steps.

It specifically comprises the steps of:
determining a preliminary control signal for the control variable,
changing the preliminary control signal into a modified control signal in order to reduce the vibration excitation, wherein
the preliminary control signal is changed into the modified control signal in such a way that
at least one frequency component from the preliminary control signal with a frequency range around a natural frequency of the vibratory component is reduced, and/or
at least one frequency component from a resulting excitation signal, which is expected from the preliminary control signal and excites the component vibration, with a frequency range around a natural frequency of the vibratory component is reduced, and
controlling the actuator on the basis of the modified control signal.

Such a wind power installation is thus prepared to carry out a method according to at least one of the aspects explained above. In particular, the installation controller is designed for this purpose. In this respect, the method can be implemented in the installation controller. For this purpose, there may be a process computer on which corresponding control programs are stored and can be executed.

In particular, the wind power installation has sensors for detecting at least one vibration of a vibratory component of the wind power installation. In particular, sensors are provided for detecting a tower vibration and/or a respective blade vibration of a rotor blade. Such sensors may be designed as strain gauges which are each arranged on the vibratory component, in particular on the tower or on the rotor blade, in particular in the region of a tower base and/or in the region of a blade root, in order to infer a movement of the respective component from recorded strains. The vibration can be detected by recording such movements for a longer period of time. In particular, provision is made for such a detected vibration to be fed back in order to derive a damping signal therefrom in order to use this to further change the modified control signal.

In principle, it also comes into consideration, and this applies to all of the aforementioned aspects which were mentioned for vibration damping, not to apply the damping signal or another damping component to the modified control signal directly, but to a signal derived from the modified control signal. In other words, the modified control signal may have been further changed, and only then is the damping signal applied. In particular, it can come into consideration that the modified control signal is a target value or target signal which is conducted via a target/actual value comparison, and the damping component is applied only after the target/actual value comparison, in particular downstream of a regulator or regulating block.

### BRIEF DESCRIPTION OF THE SEVERAL VIEWS OF THE DRAWINGS

The invention is explained in more detail below by way of example with reference to the accompanying figures.

FIG. 1 shows a perspective illustration of a wind power installation.

FIG. 2 shows a first regulating structure.

FIG. 3 shows a second simplified regulating structure.

FIG. 4 shows a diagram of a step-like function with and without a filter in the time domain and its effect in the frequency domain.

### DETAILED DESCRIPTION

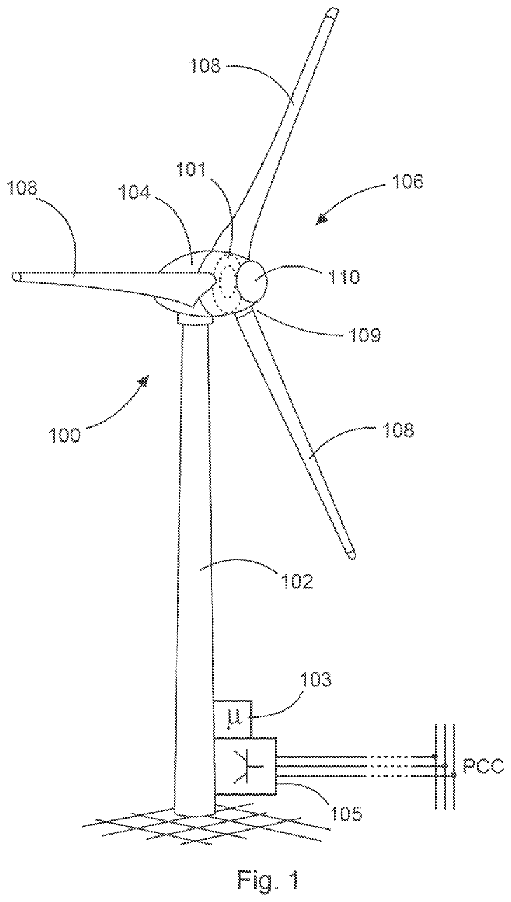

FIG. 1 shows a schematic illustration of a wind power installation according to some embodiments. The wind power installation 100 has a tower 102 and a nacelle 104 on the tower 102. An aerodynamic rotor 106 having three rotor blades 108 and a spinner 110 is provided on the nacelle 104. During the operation of the wind power installation, the aerodynamic rotor 106 is set in rotational motion by the wind and thereby also rotates an electrodynamic rotor or armature of a generator, which is coupled directly or indirectly to the aerodynamic rotor 106. The electric generator is arranged in the nacelle 104 and produces electrical energy. The pitch angles of the rotor blades 108 may be varied by pitch motors at the rotor blade roots 109 of the respective rotor blades 108.

The wind power installation 100 in this case has an electric generator 101, which is indicated in the nacelle 104. Electric power is able to be generated by way of the generator 101. Provision is made for an infeed unit 105, which may be designed in particular as an inverter, to feed in electric power. It is thus possible to generate a three-phase infeed current and/or a three-phase infeed voltage in terms of amplitude, frequency and phase, for infeed at a grid connection point PCC. This may be performed directly or else together with other wind power installations on a wind farm. Provision is made for an installation controller 103 for the purpose of controlling the wind power installation 100 and also the infeed unit 105. The installation controller 103 may also receive predefined values from an external source, in particular from a central farm computer.

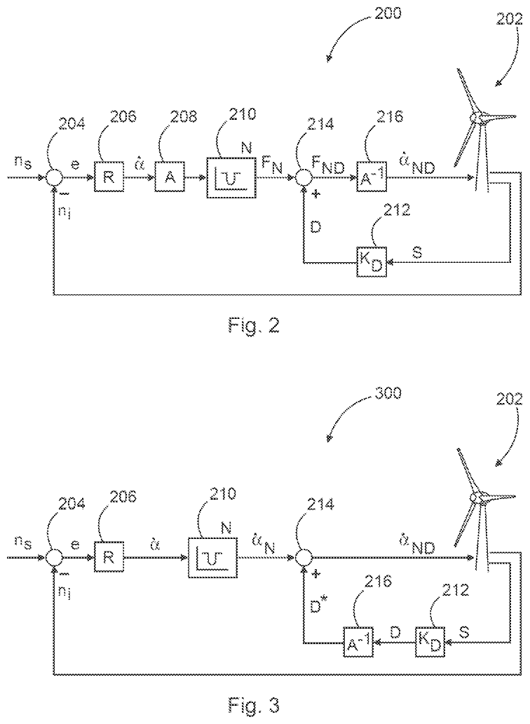

FIG. 2 shows a regulating structure 200 for illustrating a method according to some embodiments. The regulating structure 200 relates to speed regulation for the wind power installation 202 which can correspond to the wind power installation 100 in FIG. 1. The speed regulation shown here by way of example basically works in such a way that a control deviation e between the target speed nₛand the actual speed nᵢ is determined at a first summing point 204. A blade adjustment rate \dot{α} is determined via a regulator block 206. The blade adjustment rate can also be referred to as the pitch rate. Alternatively, instead of a pitch rate, it is also possible to determine a blade angle α, to mention just one possible variation.

Such a blade adjustment rate \dot{α} could be passed to the wind power installation 202, namely an actuator for adjusting the blade angles of the rotor blades. However, it is now proposed that this blade adjustment rate \dot{α}, which in this respect represents a target variable for the above-mentioned actuator, not be passed directly to the actuator, but that it be changed beforehand in order to reduce any vibration excitations, especially on the rotor blade.

In particular, it comes into consideration here that the target speed nₛ changes abruptly if, for example, the rotor speed is intended to be reduced as quickly as possible for bird protection or bat protection when a correspondingly endangered animal approaches the wind power installation. In this case, such a jump would also be reflected in the control deviation e and would result in a step-like function of the blade adjustment rate \dot{α} via the regulator block 206. Such a step-like blade adjustment rate can lead to a vibration excitation, for example of the rotor blade, but also of the tower of the wind power installation. A great change in the control deviation e and thus the blade adjustment rate \dot{α} can also result from a rapid change in the actual speed nᵢ.

In general, i.e. whether by changing the target speed or by changing the actual speed, the pitch rate leads to an excitation force F on the wind power installation. For example, a torsional force on the relevant rotor blade can be considered to be the excitation force F. However, a force on the tower in the pitch direction also comes into consideration. A force transverse to the pitch direction can also be the result of the changed pitch rate. All these forces could each be considered additionally as a linear superposition, in particular, but often it may suffice to consider only one of them, the most dominant one.

For the sake of simplicity, only one excitation force F is considered here. This excitation force F can be determined from the pitch rate via a transformation A in the transformation block 208. Thus, it is the target variable for the actuator, i.e. the pitch rate \dot{α}, which leads to the relevant excitation force F which can excite a vibration of the component under consideration, here the rotor blade, for example.

The result is therefore this excitation force F which can specifically lead to the excitation of the component under consideration.

The transformation A in the transformation block 208 thus reflects the relationship between the pitch rate \dot{α} and the excitation force F which attacks the wind power installation or the relevant component, i.e. the rotor blade in the example. This relationship can be derived from the system knowledge of the wind power installation, including the relevant actuator. This relationship can be determined by means of a calculation or by means of a simulation. It also comes into consideration to record such a relationship from measurements if the subsequent modification of the pitch rate is not implemented or is not active.

This excitation force is then subjected to a filter, in this case specifically a notch filter N, which is realized by the filter block 210. The result is therefore a filtered excitation force F_{N}.

In addition, it is also possible to perform damping, for which a vibration S of the wind power installation is detected. This vibration S is therefore the vibration of the relevant rotor blade in the case explained. Of course, it also comes into consideration to feed back another vibration for damping if another vibration is considered, for example the tower vibration, to seize on one of the examples mentioned.

This vibration S is converted into a damping term D and this is illustrated by the damping block 212.

At the second summing point 214, the damping term D is added to the filtered excitation force F_{N}, with the result that the filtered damped excitation force F _{ND} is obtained.

The filtered damped excitation force F obtained in this manner is then transformed back, namely via the inverse transformation A⁻¹. This is illustrated by the reverse transformation block 216. The result is a filtered and damped pitch rate \dot{α}_{ND}. This filtered pitch rate \dot{α}_{ND} can then be passed to the wind power installation 202, namely to the relevant actuator which performs the blade angle adjustment according to this pitch rate.

As a result, the filtered and damped pitch rate \dot{α}_{ND} is thus used instead of the pitch rate \dot{α} output by the regulator block 206. It leads to the fact that a frequency component from the frequency range around a natural frequency, which would excite a relevant natural frequency, is reduced in the excitation force. This is because the notch filter N of the filter block 210 is designed accordingly.

FIG. 3 shows a further regulating structure 300 which can correspond in terms of its effect to the regulating structure 200 in FIG. 2, if the elements of the regulating structure 200 can be assumed to be linear and time-invariant elements. For the sake of simplicity, the same reference signs are used for similar elements to those in FIG. 2. Ideally, these elements are also actually identical. However, slight deviations in the implementation can come into consideration. In particular, the regulating structure 300—the same applies to the regulating structure 200—is implemented in a process computer and, if necessary, a slight adjustment can be made there. For example, different signal amplitudes to be processed may be normalized to different reference values, which may be reflected in a processing block.

In any case, it was recognized that the elements of the regulating structure 200 can often be assumed to be linear and time-invariant elements. Under this condition, starting from FIG. 2, the reverse transformation block 216 can be moved to the left via the second summing point 216 and the sequence between the filter block 210 and the reverse transformation block 216 can then also be exchanged. The transformation block 208 and the reverse transformation block 216 then cancel each other out. When the reverse transformation block 216 is moved via the second summing point 214 as illustratively mentioned, it must, however, also be moved to the damping block 212.

This change is illustrated in FIG. 3, in which the reverse transformation block 216 cancels out the transformation block 208, with the result that both blocks are no longer illustrated there in the main branch. However, the reverse transformation block 216 is only moved and is therefore now illustrated downstream of the damping block 212.

This results in a simplified second regulating structure 300 in which the pitch rate \dot{α} is conducted via the same notch filter in the filter block 210 as the excitation force F in the first regulating structure 200. At the output of the filter block 210, the result is then a filtered pitch rate \dot{α}_{N} and this is added to a modified damping term D* at the second summing point 214. The result is the filtered and damped pitch rate \dot{α}_{ND} which is output from the reverse transformation block 216 according to FIG. 2.

The modified damping term D* results from the fact that the vibration signal S leads via the damping block 212 to the damping term D which is converted into the modified damping term D* via the inverse transformation according to the reverse transformation block 216. In practice, however, the damping block 212 and the reverse transformation block 216 can be combined into one block.

FIG. 3 thus shows a second damping structure 300 which can be used when a linear time-variant relationship can be assumed between the target variable for the relevant actuator, in this case the pitch rate \dot{α}, and the resulting excitation force F. This assumption must then of course also apply to the other relevant elements of the structure, in particular the filter block 210.

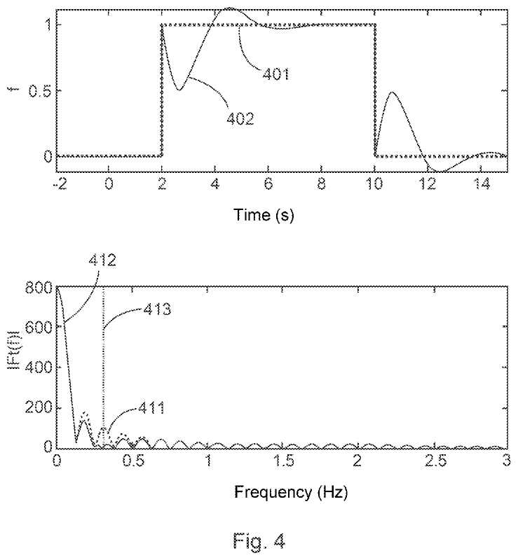

FIG. 4 shows a diagram with two individual graphs. The upper graph shows a time course of a step-like function of a generalized target variable f. The reference sign 401 is used to show the step-like target variable without modification, and the step-like target variable after modification, namely after filtering by a notch filter, is shown as a filtered jump function 402. Basically, it can be seen in this time representation that the filtering of the step-like function 401 has led to a decaying vibration component in the filtered function 402. It should be noted that the step-like function f here jumps from 0 to 1, i.e. to a normalized value, at the time t=2 seconds and jumps back to the value 0 again at 10 seconds, i.e. after 8 seconds. With each jump, the filter results in this decaying vibration component.

The lower graph shows the absolute value of the resulting frequency signal Ft(f) for the step-like function without a filter 401 and with a filter 402. The result is the unfiltered jump function in the frequency range 411 and the filtered jump function in the frequency range 412. The graph also shows an exemplary natural frequency of a vibratory component at about 0.3 Hz. The notch filter used here is set such that the filtered jump function in the frequency range 412 corresponds substantially to the unfiltered jump function in the frequency range 411, but has a significantly smaller part in the range of the natural frequency 413.

Some embodiments thus relate to a method for preventing unfavorable excitations, in particular as a result of the change in the generator torque or the blade angles, e.g. on the tower. These are in particular excitations at the natural frequency of critical components. It also relates to details on how damping methods can be integrated into the concept.

The loads on the tower base are of tremendous importance. In the lateral direction, these are caused substantially by the fact that the generator generates a torque on the rotor during the generation of electricity and the counter-torque must be derived from the tower. To do this, the top of the tower must turn. Basically, bending per se can be large enough to destroy the tower (extreme load), or the material can become fatigued by frequent deflection with smaller amplitudes (operating loads).

As the wind speed and thus the usable power constantly changes, the generator torque must often be adjusted. As a result, the torque on the tower changes and vibrations occur.

Some embodiments are used to reduce operating loads. It is observed that the tower behaves in a first approximation like a harmonic oscillator.

Harmonic oscillators react in particular to excitations close to their natural frequency.

It is therefore advisable to regulate the torque on the tower in such a way that it has as few frequency components as possible near the natural frequency of the tower.

There is one exception: It is beneficial to damp already existing vibrations of the tower by regulating the generator torque in such a way that a force is generated that counteracts the vibration. As the tower generally vibrates close to the natural frequency, the influence of this damping must be left.

Possible steps for the application where the generator torque is changed, i.e. the generator torque or its target variable forms the control variable:
A speed regulating system outputs a generator target power, e.g. when adjusting the speed to an optimum speed in order to make optimum use of the wind.

Calculation of the target torque corresponding to the force then acting on the tower. This target torque can be a bending torque that acts on the tower, especially in relation to a tower base. It can also be a torsional moment of the tower. A resulting excitation signal expected from the generator target power is therefore calculated.
This variable, i.e. the expected resulting excitation signal, is filtered by means of a notch filter in order to reduce frequency components close to the tower natural frequency.
Add an additional damping term that counteracts the current tower vibration in order to obtain a filtered and damped excitation signal.
Calculate a target value from the target torque obtained in this manner and head for it. Thus, a filtered and damped control signal is formed from the filtered and damped excitation signal and then forms the changed generator target power to be headed for, i.e. set. In principle, instead of the generator target power or generally instead of the generator power, a generator target torque or generator torque can be used.

In the longitudinal direction, the forces on the tower are essentially caused by the wind losing momentum through the rotor. The counterforce acts on the blades and must be diverted via the tower. To do this, the tower must bend backward and the regulation can be applied in a similar way.

However, the concept is more difficult to implement, as the force must be regulated via the pitch angle, i.e. the blade angle, but this is much more sluggish than the generator torque.

The concept can also be applied in a simplified manner if it is observed that a reduced excitation is also an advantage, but a reliable calculation of the forces, especially in the longitudinal direction, is difficult. This would require precise knowledge of the aerodynamics, i.e. in particular of the spatial wind field. Alternatively, the influence of the pitch angle on the force on the tower can be developed and accordingly the pitch angle itself can be filtered. The pitch rate itself could be filtered more favorably, as ideal filtering, derivation and integration can be commutated, i.e. the signal sequence thereof can be changed. The disadvantage of this simplification is that, for example, a change in the wind speed is not picked up.

The natural frequency of the tower is known early in the development process of a tower and is a central variable. It is used directly here. This avoids parameterization effort.

There is freedom of choice in the choice of the notch filter; in particular, frequencies further away from the natural frequency can be damped to a lesser extent in order to be able to better control the speed or can be damped to a greater extent in order to save operating loads.

It was recognized that the principle can be applied even further, i.e. in particular to other variables and situations. All variables that have a significant, linearizable influence on the corresponding forces, such as intermediate variables for calculating the target pitch rate, basically come into consideration.

The calculation steps in general:
The target variable of an actuator is calculated as an input variable; it is calculated as a preliminary control variable.
Conversion of the target variable to the relevant force that excites the component under consideration (rotor blade, tower). Thus, an expected resulting excitation signal is calculated from the preliminary control variable.
Filter this variable by means of a notch filter in order to reduce frequency components close to the tower natural frequency. The expected resulting excitation signal is therefore filtered by means of a notch filter.
Add a damping term that counteracts the vibration of the component under consideration. Therefore, as may be optional, the damping term is added to the filtered expected resulting excitation signal.
Calculate the variable obtained in this manner back to the original target variable of the actuator. Thus, the damped, filtered, expected resulting excitation signal is calculated back, i.e. transformed back, into the modified control signal.

A preferred application is proposed for the field of Rapid Animal Protection, i.e. rapid protection of endangered animals that fly toward the wind power installation, namely birds or bats: If a detection system, which can be designed as an external system, detects that a bird could soon arrive at the installation, the speed is reduced by turning out the rotor blades, which can also be referred to as pitching out of the blades, and setting the highest possible generator torque in order to protect this bird. At a reduced speed, it is at best possible to provide a reduced active electrical power. A rapid reaction allows for a later reaction, as a result of which it is possible not only to shorten but also to completely avoid phases of lower production, as birds can veer away and the critical flight zone becomes smaller at the same flight speed.

On the other hand, rapid pitching out is accompanied by a springing out of the tower, and a change in the generator torque changes the balance of forces in the lateral direction. Both lead to tower vibrations which may damage components or may cause additional costs for stronger components.

As a result, it was recognized that it is important to find a fast regulating system with low tower vibration.

It would be possible to filter different variables in the sense described above. This is particularly proposed for a target acceleration power.

As soon as a signal for switching on bird protection arrives, i.e. a signal that triggers a curtailment or stopping of the wind power installation in order to protect the bird, the reaction should be as fast as possible, that is to say the native reaction would be immediate pitching out at the highest speed. On the other hand, such a pulse has a broad excitation spectrum, which also excites the particularly sensitive frequencies around the natural frequency and thus leads to strong vibrations of the tower. In the event of an emergency shutdown, the problem can be solved by a plurality of phases at different speeds.

A basic idea is now to use a notch filter around the natural frequency for regulation in order to specifically remove the problematic excitation frequencies.

One advantage of the method is that the natural frequency of the tower is sufficient for parameterization. This is known early in development. Thus, a significant part of the method can be parameterized fully automatically and without tuning.

The following applications are proposed:
Rapid Animal Protection/RAP events
Profiled emergency running, during which the wind power installation is quickly shut down on a predetermined trajectory. The following advantages were recognized in this respect: Automatable parameterization, complexity low enough for safety-oriented implementation, possible load saving
Generally any pitching, i.e. a blade adjustment for any situations, at least in those cases in which a load saving or load reduction can be achieved
Specification of the generator target torque value for various applications
To prevent collective blade modes from escalating. Here it was recognized that such collective blade modes, i.e. vibrations on all rotor blades when the rotor blades are adjusted together, can cause an escalation of vibrations on the rotor blades, as they affect the measured speed and this affects the generator torque. Proposed filtering with a notch filter can also achieve an improvement, which can be applied to the speed in order to minimize an excitation here.

Some embodiments essentially represent a load reduction option, the essential parameter of which is known early and simply.

European patent application no. 23155804.0, filed Feb. 9, 2023, to which this application claims priority, is hereby incorporated herein by reference in its entirety. Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for controlling a wind power installation, wherein:
the wind power installation has a tower, a generator and a rotor with rotor blades whose blade angle can be adjusted,
an operating point is characterized by an installation power and a rotor speed,
to change or maintain the operating point, at least one actuator is controlled in each case via a control variable, and
controlling the actuator affects a vibration excitation of at least one component vibration of a vibratory component of the wind power installation,
wherein the method comprises:
determining a preliminary control signal for the control variable,
changing the preliminary control signal into a modified control signal in order to reduce the vibration excitation, wherein
the preliminary control signal is changed into the modified control signal in such a way that
at least one frequency component from the preliminary control signal with a frequency range around a natural frequency of the vibratory component is reduced, and/or
at least one frequency component from a resulting excitation signal, which is expected from the preliminary control signal and excites the component vibration, with a frequency range around the natural frequency of the vibratory component is reduced, and
controlling the actuator on the basis of the modified control signal.

2. The method as claimed in claim 1, wherein:
in order to damp the at least one component vibration, a damping signal is applied to the modified control signal, in particular in such a way that
the damping signal is determined on the basis of at least one detected component vibration.

3. The method as claimed in claim 1, wherein:
in order to change the preliminary control signal into the modified control signal, use is made of a band-stop filter, in particular a notch filter, which reduces the at least one frequency component from the preliminary control signal.

4. The method as claimed in claim 1, wherein:
the preliminary control signal is step-like, and/or
the preliminary control signal is a specified target value, and/or
the preliminary control signal is specified for changing the operating point.

5. The method as claimed in claim 1, wherein:
the control variable is a target torque value of the generator of the wind power installation, and in particular the target torque value is determined from a received target power value,
the resulting vibration excitation is an excitation of a tower vibration, in particular a bending vibration of the tower, and
the modified control signal is determined in such a way that a frequency component around the natural frequency of the tower is reduced, in particular with reference to a bending vibration of the tower.

6. The method as claimed in claim 1, wherein:
the control variable is a blade angle or a pitch rate for adjusting a blade angle in each case, and in particular the blade angle or the pitch rate is determined from a request for adjustment and/or a change in the rotor speed,
the resulting vibration excitation is an excitation of at least one blade vibration, in particular a torsional vibration of the blade, and/or a collective vibration mode of the blades together with a spinner or a hub, and
the modified control signal is determined in such a way that a frequency component around the natural frequency of the blade is reduced, in particular with reference to the torsional vibration of the blade, or the modified control signal is determined in such a way that a frequency component around the natural frequency of the collective vibration mode of the blades and the spinner or the hub is reduced.

7. The method as claimed in claim 1, wherein:
the at least one actuator is controlled via the at least one control variable in order to change the current operating point to a new operating point, and
the wind power installation at the new operating point relative to the current operating point has a reduced installation power, and/or
a reduced speed, and/or
the new operating point is an installation stop, and/or
the preliminary control signal is intended for the fastest possible change to the new operating point, in particular for an emergency shutdown of the wind power installation and/or emergency braking of the rotor.

8. The method as claimed in claim 1, wherein:
the preliminary control signal is specified as a time course, with values that vary several times and/or continuously, in particular
with a plurality of temporally distributed supporting points, wherein the course has a linear section between two adjacent supporting points in each case.

9. The method as claimed in claim 1, wherein:
depending on a target working point to be headed for, in particular for carrying out an emergency stop,
and optionally depending on a current working point,
a time course of the preliminary control signal is selected, in particular from a table.

10. The method as claimed in claim 1, wherein:
the control variable is a blade angle or a pitch rate for adjusting a blade angle in each case, and in particular the blade angle or the pitch rate is determined from a request for adjustment and/or a change in the rotor speed, and
the modified control signal is determined in such a way that
at least one frequency component from the preliminary control signal with a frequency range around at least one natural frequency of the tower, in particular around a natural frequency of bending of the tower in the pitch direction, is reduced, and/or
at least one frequency component from a resulting excitation signal, which is expected from the preliminary control signal and excites the tower vibration, with a frequency range around a natural frequency of the tower, in particular around a natural frequency of bending of the tower in the pitch direction, is reduced.

11. The method as claimed in claim 1, wherein:
the at least one natural frequency is determined during operation from recorded measurement variables, in particular by using parameter identification, and
the preliminary control signal is changed into the modified control signal using this at least one determined natural frequency, and/or
the preliminary control signal is changed into the modified control signal adaptively by adapting at least one natural frequency used to the at least one detected natural frequency.

12. The method as claimed in claim 1, wherein:
a speed reduction is specified depending on an endangered flying animal, in particular a bird or bat, approaching the wind power installation,
depending on the specified speed reduction, a blade adjustment or pitch rate for adjusting the blade angle is determined as a preliminary control signal, and
the preliminary control signal determined in this manner is changed into the modified control signal.

13. A wind power installation, wherein:
the wind power installation has a tower, a generator and a rotor with rotor blades whose blade angle can be adjusted, and
an operating point is characterized by an installation power and a rotor speed, wherein
the wind power installation is prepared to be operated in such a way that to change or maintain the operating point, at least one actuator is controlled in each case via a control variable, and
controlling the actuator affects a vibration excitation of at least one component vibration of a vibratory component of the wind power installation, and wherein
the wind power installation is prepared, in particular has an installation controller which is prepared, to carry out a method comprising:
determining a preliminary control signal for the control variable,
changing the preliminary control signal into a modified control signal in order to reduce the vibration excitation, wherein
the preliminary control signal is changed into the modified control signal in such a way that
at least one frequency component from the preliminary control signal with a frequency range around a natural frequency of the vibratory component is reduced, and/or
at least one frequency component from a resulting excitation signal, which is expected from the preliminary control signal and excites the component vibration, with a frequency range around a natural frequency of the vibratory component is reduced, and
controlling the actuator on the basis of the modified control signal.

14. The wind power installation as claimed in claim 13, wherein
sensors are provided for detecting at least one vibration of a vibratory component of the wind power installation.
